(19) United States
(12) Patent Application Publication
(10) Pub. No.: US 2023/0009756 A1
(43) Pub. Date: Jan. 12, 2023

(54) ELECTRONIC DEVICE, METHOD, AND COMPUTER-READABLE MEDIUM FOR QUICKLY SWITCHING CHANNELS

(71) Applicant: ARRIS Enterprises LLC, Suwanee, GA (US)

(72) Inventors: Yong LIANG, Shanghai (CN); Qi WANG, Shanghai (CN); Ye-Yi CUI, Shanghai (CN); Xue-Wei ZHAO, Shanghai (CN)

(73) Assignee: ARRIS Enterprises LLC, Suwanee, GA (US)

(21) Appl. No.: 17/719,962

(22) Filed: Apr. 13, 2022

(30) Foreign Application Priority Data
Jul. 7, 2021 (CN) 202110766022.9

(51) Int. Cl. H04N 21/422

(52) U.S. Cl. CPC H04N 21/42216; H04N 21/42215; H04N 21/4221

(57) ABSTRACT

The present disclosure relates to an electronic device, a method, and a computer-readable medium for quickly switching channels. An electronic device is provided. The electronic device includes: a memory having instructions stored thereon; and a processor. The processor is configured to execute the instructions stored on the memory to cause the electronic device to execute the following operations: playing a first program of a first channel, wherein the first program is a live program; receiving user input when playing the first program; and in response to receiving the user input, switching from the first channel to a second channel and playing a second program of the second channel, wherein the second program is an OTT program.

### TECHNICAL FIELD

The present disclosure relates to a video playback device in general, and more specifically, to an electronic device, a method, and a computer-readable medium for quickly switching channels.

### BACKGROUND ART

When using a conventional set top box, channel switching usually takes 0.5 to 2 seconds to display video content. When using a new generation of set top boxes, a user not only watches live programs but also watches OTT programs in various OTT (Over The Top) applications (for example, YouTube, Netflix, Amazon Prime, iQiyi, etc.).

When a user who uses such a set top box wants to switch from a channel of a live program to a channel of an OTT program, the user usually takes the following steps. The user exits a current live program to return to a home page of the set top box, and then starts an OTT application from the home page and selects an OTT program that the user wants to watch. The time spent on these operations is much longer than that in channel switching between live programs, thus bringing poor user experience.

In another kind of conventional set top box, an OTT application dedicated to a specific OTT content provider is used as a plug-in of a live streaming application. As a result, the user can activate the plug-in to enter a website home page of the OTT content provider to browse and select programs. When the user exits the home page, the user also exits the plug-in and returns to the live streaming application.

### SUMMARY OF THE INVENTION

Some aspects of the present disclosure relate to an electronic device. The electronic device includes: a memory having instructions stored thereon; and a processor. The processor is configured to execute the instructions stored on the memory to cause the electronic device to execute the following operations: playing a first program of a first channel, wherein the first program is a live program; receiving user input when playing the first program; and in response to receiving the user input, switching from the first channel to a second channel and playing a second program of the second channel, wherein the second program is an OTT program.

In some embodiments, the processor is further configured to execute instructions stored on the memory to cause the electronic device to execute the following operations: receiving another user input when playing the second program; and in response to receiving the other user input, switching from the second channel to a third channel and playing a third program of the third channel, wherein the third program is a live program.

In some embodiments, each of the user input and the other user input includes: inputting a channel number by a user, or pressing a previous channel button or a next channel button by the user.

In some embodiments, the second channel is associated with a plurality of OTT programs from an OTT content provider.

In some embodiments, the plurality of OTT programs are associated with one of the following: a specific channel of the OTT content provider, a specific host of the OTT content provider, a specific topic of the OTT content provider, a subscription of the user at the OTT content provider, and a recommendation of the OTT content provider.

In some embodiments, in response to switching from the first channel to the second channel, the plurality of OTT programs will be played sequentially. Moreover, in an electronic program guide of the electronic device, previews of the plurality of OTT programs are sequentially displayed corresponding to the second channel.

In some embodiments, the first program is played by a main application for playing live programs, and the second program is played by an OTT application for playing OTT programs from the OTT content provider.

In some embodiments, when the OTT application plays the second program, the main application remains active in background and monitors user input.

In some embodiments, the association of the second channel with the plurality of OTT programs is set by a user.

Other aspects of the present disclosure relate to an execution method of the electronic device. The method includes: playing a first program of a first channel, wherein the first program is a live program; receiving user input when playing the first program; and in response to receiving the user input, switching from the first channel to a second channel and playing a second program of the second channel, wherein the second program is an OTT program.

In some embodiments, the method further includes: receiving another user input when playing the second program; and in response to receiving the other user input, switching from the second channel to a third channel and playing a third program of the third channel, wherein the third program is a live program.

In some embodiments, each of the user input and the other user input includes: inputting a channel number by a user, or pressing a previous channel button or a next channel button by the user.

In some embodiments, the second channel is associated with a plurality of OTT programs from an OTT content provider.

In some embodiments, the plurality of OTT programs are associated with one of the following: a specific channel of the OTT content provider, a specific host of the OTT content provider, a specific topic of the OTT content provider, a subscription of the user at the OTT content provider, and a recommendation of the OTT content provider.

In some embodiments, in response to switching from the first channel to the second channel, the plurality of OTT programs will be played sequentially. Moreover, in an electronic program guide of the electronic device, previews of the plurality of OTT programs are sequentially displayed corresponding to the second channel.

In some embodiments, the first program is played by a main application for playing live programs, and the second program is played by an OTT application for playing OTT programs from the OTT content provider.

In some embodiments, when the OTT application plays the second program, the main application remains active in background and monitors user input.

In some embodiments, the association of the second channel with the plurality of OTT programs is set by a user.

Other aspects of the present disclosure relate to a non-transitory computer-readable medium, and the non-transitory computer-readable medium has instructions stored thereon, and when executed by a processor of an electronic device, the instructions cause the electronic device to execute any one of the methods described above.

Other aspects of the present disclosure relate to an apparatus, including a component for executing steps of any one of the methods described above.

### BRIEF DESCRIPTION OF THE ATTACHED DRAWINGS

For a better understanding of the present disclosure and to show how to implement the present disclosure, examples are herein described with reference to the attached drawings, wherein:

FIG. 1 is a block diagram illustrating an exemplary electronic device 100 according to some embodiments.

FIG. 2 is a schematic diagram showing a scene where a user watches a video through a set top box according to an embodiment of the present disclosure.

FIG. 3 is a flowchart of a method for quick channel switching between a live program and an OTT program according to an embodiment of the present disclosure.

FIG. 4 is a schematic diagram showing an electronic program guide according to an embodiment of the present disclosure.

It should be noted that throughout the attached drawings, similar reference numerals and signs refer to corresponding parts. In addition, multiple instances of the same part are designated by a common prefix separated from the instance number by a dash.

### SPECIFIC EMBODIMENTS

The following detailed description is made with reference to the attached drawings, and the following detailed description is provided to facilitate comprehensive understanding of various exemplary embodiments of the present disclosure. The following description includes various details to facilitate understanding. However, these details are merely considered as examples, not for limiting the present disclosure. The words and phrases used in the following description are only used to enable a clear and consistent understanding of the present disclosure. In addition, for clarity and brevity, descriptions of well-known structures, functions, and configurations may be omitted. Those of ordinary skill in the art will realize that various changes and modifications can be made to the examples described in the present specification without departing from the gist and scope of the present disclosure.

As described above, in existing set top boxes, when a user wants to switch from a live program to an OTT program, the user may exit from a live streaming application to a home page of a set top box and activate a desired OTT application from the home page, or the user may activate an OTT application as a plug-in in the live streaming application. In both cases, the user is only provided with a home page of an OTT content provider (for example, the home page of YouTube) for the user to select OTT programs. The user needs to make further selections to watch OTT programs of interest. This makes the user clearly feel a gap between a live program and an OTT program, and at the same time, it takes a long time to complete the switching of program broadcast. This brings poor user experience.

A technical solution of the present disclosure provides a method and an electronic device for quick channel switching between a live program and an OTT program. The method and the electronic device of the present disclosure will enable users to experience seamless and quick switching between live programs and OTT programs. In one or a plurality of embodiments according to the present disclosure, the electronic device may be a set top box, or a television or other video playback devices including the function of the set top box.

Next, the embodiments of the present disclosure will be described in detail with reference to the attached drawings.

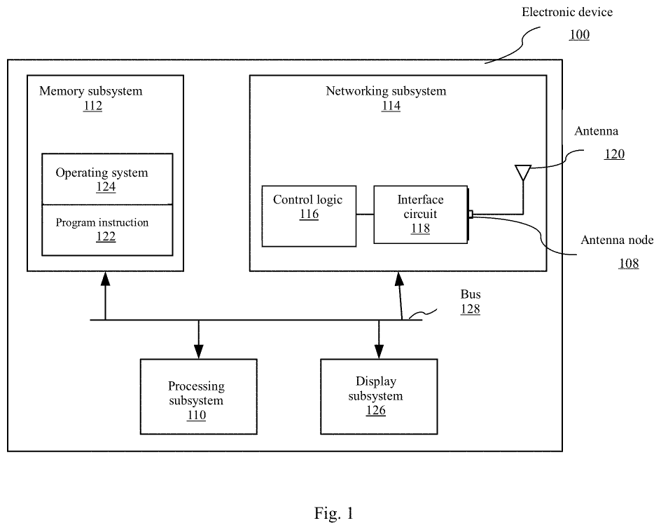

FIG. 1 presents a block diagram illustrating an exemplary electronic device 100 according to some embodiments.

The electronic device 100 may be used to implement various embodiments of the method according to the present disclosure. The electronic device 100 may comprise a processing subsystem 110, a memory subsystem 112, and a networking subsystem 114. The processing subsystem 110 includes one or a plurality of devices configured to perform computing operations. For example, the processing subsystem 110 may comprise one or a plurality of microprocessors, ASICs, microcontrollers, programmable logic devices, graphics processing units (GPU) and/or one or a plurality of digital signal processors (DSPs).

The memory subsystem 112 comprises one or a plurality of devices for storing data and/or instructions used for the processing subsystem 110 and the networking subsystem 114. For example, the memory subsystem 112 may include a dynamic random access memory (DRAM), static random access memory (SRAM), and/or other types of memory (sometimes collectively or individually referred to as “computer-readable storage medium”).

In some embodiments, the memory subsystem 112 is coupled to one or a plurality of high-capacity mass storage devices (not shown). For example, the memory subsystem 112 may be coupled to a magnetic or an optical driver, a solid state driver, or another type of mass storage device. In these embodiments, the electronic device 100 may use the memory subsystem 112 as a fast-access storage of frequently used data, while the mass storage device is used for storing infrequently used data.

The networking subsystem 114 comprises one or a plurality of devices that are configured to be coupled to and/or communicate over wired and/or wireless networks (i.e., to execute network operations), comprising: control logic 116, interface circuit 118, and one or a plurality of antennas 120 (or antenna elements). (Although FIG. 1 includes one or a plurality of antennas 120, in some embodiments, the electronic device 100 includes one or a plurality of nodes, such as node 108, which can be coupled to one or a plurality of antennas 120. Therefore, the electronic device 100 may or may not include one or a plurality of antennas 120.) For example, the networking subsystem 114 may include a Bluetooth networking system, a cellular networking system (for example, 3G/4G/5G networks, such as UMTS, LTE, etc.), a USB networking system, a networking system based on the standards described in IEEE 802.11 (for example, Wi-Fi networking system), Ethernet networking system, and/or another networking system.

In the electronic device 100, a bus 128 is used to couple the processing subsystem 110, the memory subsystem 112, and the networking subsystem 114 together. The bus 128 may comprise electrical, optical, and/or electro-optical connections of the subsystems through which commands, data and the like may be transmitted. Although only one bus 128 is shown for clarity, different embodiments may comprise electrical, optical, and/or electro-optical connections of different numbers or configurations among the subsystems.

In some embodiments, the electronic device 100 includes a display subsystem 126 for showing information on a display device, which may include a display driver and a display, such as a liquid crystal display and a multi-touch screen, etc.

Although specific components are used to describe the electronic device 100, in alternative embodiments, different components and/or subsystems may exist in the electronic device 100. For example, the electronic device 100 may include one or a plurality of additional processing subsystems, memory subsystems, networking subsystems, and/or display subsystems. In addition, the electronic device 100 may not have one or a plurality of the subsystems. Furthermore, in some embodiments, the electronic device 100 may include one or a plurality of additional subsystems not shown in FIG. 1. Also, although separate subsystems are shown in FIG. 1, in some embodiments, some or all of the given subsystems or components may be integrated into one or a plurality of the other subsystems or components in the electronic device 100. For example, in some embodiments, a program instruction 122 is included in an operating system 124 and/or the control logic 116 is included in the interface circuit 118.

In some embodiments, the networking subsystem 114 and/or integrated circuit includes a configuration mechanism (such as one or a plurality of hardware and/or software mechanisms) that configures the radio device for transmission or reception on a given communication channel (e.g., a given carrier frequency). For example, in some embodiments, the configuration mechanism may be used to switch the radio from monitoring and/or transmitting on a given communication channel to monitoring and/or transmitting on a different communication channel. (It should be noted that “monitoring” used here involves receipt of signals from other electronic devices and possibly execution of one or a plurality of operations over the received signals.)

Although Wi-Fi and/or Ethernet communication protocols are used in the above discussion as illustrative examples, in other embodiments, various communication protocols may be used, and more generally, communication technologies may be used. Therefore, communication technologies can be used in various network interfaces.

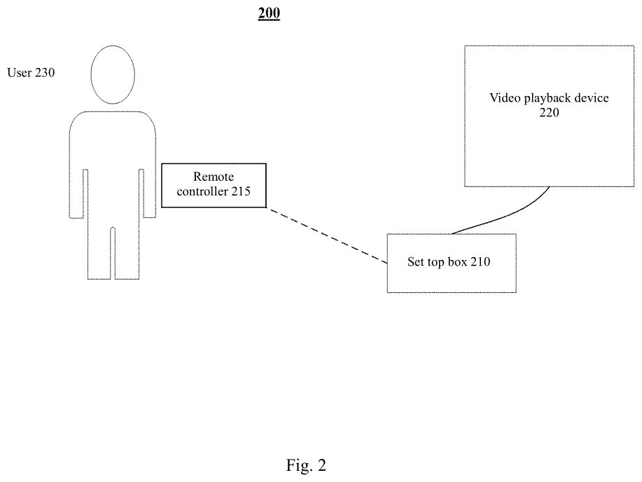

FIG. 2 is a schematic diagram showing a scene where a user watches a video through a set top box according to an embodiment of the present disclosure.

A set top box 210 may be connected to a video playback device 220 such as a television through a cable or the like, so as to send video data received from the Internet, a cable TV network, a satellite TV network and the like to the video playback device 220 for playing. The set top box 210 may have a dedicated remote controller 215 paired with the set top box. In general, the remote controller 215 wirelessly communicates with the set top box 210 through infrared signals. A user 230 may send a control signal to the set top box 210 by selecting and pressing a button on the remote controller 215 to, for example, control the set top box 210 to start playing of a selected video, pause the playing of a current video, switch channels, enter a standby state, navigate in an electronic program guide and select a program, and select a specific operation in a dialog box that pops up on a TV screen, etc.

Although the user 230 uses the remote controller 215 to control the operation of the set top box 210 in the scene shown in FIG. 2 as an example, in another embodiment, the user 230 may use a mobile device such as a mobile phone or a tablet computer to control the operation of the set top box 210. In such an embodiment, the user 230 may control the set top box 210 by operating virtual keys displayed on the screen of the mobile device. The mobile device may communicate with the set top box 210 through, for example, Bluetooth, WiFi, or other wireless communication protocols.

In the example shown in FIG. 2, the set top box 210 may include the structure of the electronic device 100 shown in FIG. 1. Although the set top box 210 and the video playback device 220 are shown as two separate devices in the scene shown in FIG. 2 as an example, in another embodiment, the set top box 210 and the video playback device 220 may be integrated into one device, such as a smart TV. In such an embodiment, the integrated device may include the structure of the electronic device 100 as shown in FIG. 1.

Although it is referred to as a set top box herein, the set top box 210 may be, for example, a hardware electronic device that can combine the functions of a modem, an access point, and/or a router. The present disclosure further proposes that the modem 210 may include, but is not limited to, functions of a smart media device (SMD) that can decode audio/video contents and play OTT contents.

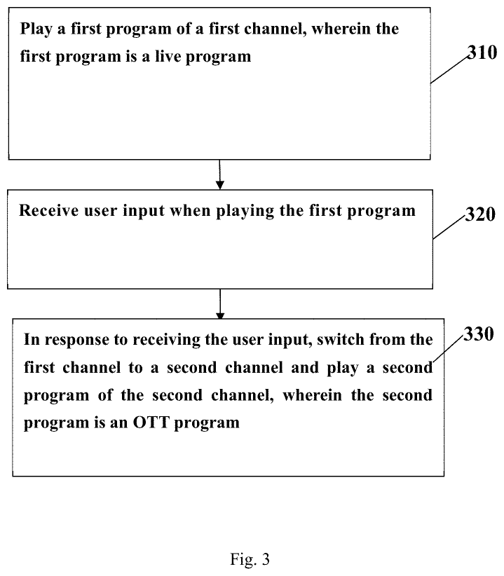

FIG. 3 is a flowchart of a method 300 for quick channel switching between a live program and an OTT program according to an embodiment of the present disclosure. The method 300 may be executed by, for example, the electronic device 100 shown in FIG. 1 or the set top box 210 shown in FIG. 2.

As shown in FIG. 3, in step 301, a first program of a first channel is played. Here, the first program is a live program, and the first channel is a live channel. In an example, the first channel may be CNN International, and the first program may be CNN African Voices in the channel. According to an embodiment of the present disclosure, the first program is played by a main application. The main application runs in the set top box 210 and is used to play live programs.

In step 302, user input is received when the first program is played. The user input may include, for example, one of the following: inputting a channel number by a user, or pressing a previous channel button or a next channel button by the user. For example, the user may input a specific channel number by pressing physical number buttons on the remote controller 215 or pressing virtual number buttons on a mobile device to directly switch to the channel. For example, in order to input the channel number 100, the user may press number buttons 1, 0, 0 in this order. In addition, the user may also switch to the previous channel or the next channel of the current channel by pressing the previous channel button or the next channel button.

In step 303, in response to receiving the user input, it is switched to the second channel from the first channel and a second program of the second channel is played. Here, the second program is an OTT program. In an example, the second channel may be the ABC live news channel on YouTube, and the second program may be the evening news program in the ABC live news channel. In another example, the second channel may be the WWE channel on YouTube, and the second program may be a wrestling match in the WWE channel. According to an embodiment of the present disclosure, the second program is played by an OTT application. The OTT application runs in the set top box 210 and is used to play OTT programs from a specific OTT content provider.

According to an embodiment of the present disclosure, an OTT application corresponds to a specific OTT content provider. For example, for contents from Amazon Prime, it is necessary to use a dedicated OTT application to watch, and for contents from YouTube, it is necessary to use another OTT application to watch. According to an embodiment of the present disclosure, it is also possible to use one OTT application to watch OTT programs from a plurality of OTT content providers.

The set top box according to the present disclosure supports a multi-application framework. For example, the set top box runs the KreaTV stack. That is, after being turned on, the set top box starts the main application for playing live programs and also starts an OTT application (for example, YouTube, Netflix, Amazon Prime, etc.) at the same time. In this framework, only one application can run in the foreground, while other applications run in the background.

According to an embodiment of the present disclosure, the method 300 may further include: receiving another user input when playing the second program; and in response to receiving the other user input, switching from the second channel to a third channel and playing a third program of the third channel. Here, the third program is a live program. The other user input may include, for example, one of the following: inputting a channel number by a user, or pressing a previous channel button or a next channel button by the user. In other words, according to the present disclosure, it is not only possible to switch from the playing of a live program to the playing of an OTT program by operating the remote controller to change the channel number, but also possible to switch from the playing of an OTT program to the playing of a live program. This provides users with a seamless switching between live channels and OTT channels, thereby providing users with a smooth experience. According to an embodiment of the present disclosure, when the OTT application plays the second program (i.e., an OTT program), the main application remains active in the background and monitors user input. This configuration enables directly switching from the playing of an OTT program by the OTT application to the playing of a selected live program by the main application.

According to an embodiment of the present disclosure, the second channel may be associated with a plurality of OTT programs from an OTT content provider. According to an embodiment of the present disclosure, the association of the second channel with the plurality of OTT programs is set by a user. In other words, the technical solution of the present disclosure provides the user with the following function: associating specific content (for example, a series of content) from a specific OTT content provider with a channel number in the set top box, so that the associated content will be played directly when the channel number is input. According to an embodiment of the present disclosure, the plurality of OTT programs associated with a channel number may be associated with one of the following: a specific channel of the OTT content provider, a specific host of the OTT content provider, a specific topic of the OTT content provider, a subscription of the user at the OTT content provider, and a recommendation of the OTT content provider.

In other words, according to the present disclosure, the user may customize the channels of the set top box. For examples, the user may associate a specific channel (for example, the WWE channel) on YouTube with channel number 101. Then, a series of videos from the WWE channel will be played when switching to the channel 101. For examples, the user may associate a host (for example, Felix) on YouTube with channel number 102. Then, a series of videos uploaded by the host will be played when switching to the channel 102. For examples, the user may associate a topic (for example, #coronavirus) on YouTube with channel number 103. Then, a series of videos related to the topic will be played when switching to the channel 103. For examples, the user may associate the user's subscription on YouTube with channel number 104. Then, a series of videos related to the user's subscription will be played when switching to the channel 104. For examples, the user may associate a recommended content of YouTube with channel number 105. Then, a series of videos related to the recommended content will be played when switching to the channel 105. In addition, for example, the user may also associate a specific content (for example, an episode) on another OTT content provider (for example, Netflix, Amazon Prime) with channel number 106. Then, a series of videos of the episode will be played when switching to the channel 106.

In order to enable the user to set the association between channel numbers and OTT programs, according to an embodiment of the present disclosure, an open API provided by an OTT application may be called in the main application to obtain a channel list of OTT contents of the user's interest. Then, the user may select favorite channels or programs in the OTT application and add them to the electronic program guide of the main application to be associated with a channel number. In an example, the electronic program guide may have the following structure:

| Channels | Live channel provided | |
|---|---|---|
| 1 to 100 | by main application | |
| Channel | ABC live news in | https://www.youtube.com/ |
| 101 | YouTube | watch?v=w_Ma8oQLmSM |
| Channel | An episode in Amazon | https://www.primevideo.com/ |
| 102 | Prime | asinlist=B00OVLYY6A |
| . . . | . . . | . . . |

Just as an example, in the above table, each OTT channel may be associated with a URL returned by calling the API of the OTT application.

In an example, channels 1 to 100 may be live channels, and channels 101 to 110 may be OTT channels. When the user switches from channel 100 to channel 101 by operating the remote controller 215 for example, the set top box 210 hides the main application and displays the YouTube application, and immediately plays a corresponding program of the WWE channel on YouTube; when the user switches from channel 101 to channel 102 by operating the remote controller 215 for example, the set top box 210 keeps hiding the main application and displaying the YouTube application, and immediately plays a video uploaded by the host Felix on YouTube; and when the user switches from channel 102 to channel 1 by operating the remote controller 215 for example, the set top box 210 displays the main application and hides the YouTube application, and immediately plays a live program corresponding to channel 1. When switching from a live program to an OTT program, if the network speed is fast enough, it usually takes less than 1 second, thus providing quick channel switching.

According to an embodiment of the present disclosure, in response to switching from the first channel to the second channel, the plurality of OTT programs associated with the second channel will be played sequentially. In addition, in the electronic program guide of the set top box, previews of the plurality of OTT programs are sequentially displayed corresponding to the second channel. In other words, when there are a plurality of OTT programs associated with a channel number (for example, a host uploads a plurality of videos), the plurality of OTT programs are played in sequence as the content of the second channel.

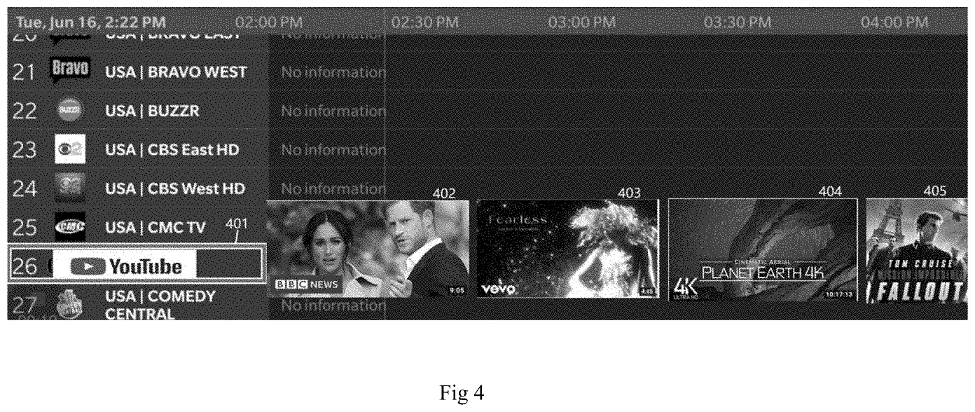

FIG. 4 is a schematic diagram showing an electronic program guide according to an embodiment of the present disclosure. In the electronic program guide shown in FIG. 4, channel numbers 21 to 25 and 27 correspond to live channels, and channel number 26 corresponds to YouTube recommended content (401). In FIG. 4, corresponding to channel 26, previews (402 to 405) of a plurality of recommended OTT programs are sequentially displayed. In this case, when the user instructs to switch to channel 26 by operating the remote controller, the OTT program represented by the preview 402 will be played first, and the duration of the program is 9 minutes and 5 seconds. When the playing of the program 402 is finished, the set top box (OTT application) will continue to play the next OTT program 403, and so on. In the electronic program guide shown in FIG. 4, the user may use navigation buttons on the remote controller to move among the displayed previews (402 to 405) of the plurality of OTT programs. When the user selects one of the previews (402 to 405), a corresponding program will be played.

The present disclosure may be realized as any combination of devices, systems, integrated circuits, and computer programs on non-transient computer-readable media. One or a plurality of processors may be realized as an integrated circuit (IC), an application-specific integrated circuit (ASIC) or a large-scale integrated circuit (LSI), a system LSI, a super LSI, or an ultra LSI component that performs some or all of the functions described in the present disclosure.

According to each step of the method of the present disclosure, it may also be executed respectively by a plurality of components included in the device. According to an embodiment, these components can be implemented as computer program modules established to realize various steps of the method, and a device including these components may realize the program module structure of the method by computer programs.

The present disclosure includes the use of software, applications, computer programs, or algorithms. Software, application programs, computer programs or algorithms can be stored on a non-transient computer-readable medium, so that a computer with one or a plurality of processors can execute the aforementioned steps and the steps described in the attached drawings. For example, one or a plurality of memories store software or algorithms by executable instructions, and one or a plurality of processors can associate the execution of a set of instructions of the software or algorithms to provide channel switching in any number of wireless networks according to the embodiments described in this disclosure.

Software and computer programs (also called programs, software applications, applications, components, or codes) include machine instructions for programmable processors, and may be realized in high-level procedural languages, object-oriented programming languages, functional programming languages, logic programming languages, or assembly languages or machine languages. The term “computer-readable medium” refers to any computer program product, apparatus or device used to provide machine instructions or data to the programmable data processor, e.g., magnetic disks, optical disks, solid-state storage devices, memories, and programmable logic devices (PLDs), including computer-readable media that receive machine instructions as computer-readable signals.

For example, the computer-readable medium may include the dynamic random access memory (DRAM), random access memory (RAM), read only memory (ROM), electrically erasable read only memory (EEPROM), compact disk read only memory (CD-ROM) or other optical disk storage devices, magnetic disk storage devices or other magnetic storage devices, or any other medium that can be used to carry or store the required computer-readable program codes in the form of instructions or data structures and can be accessed by a general or special computer or a general or special processor. As used herein, magnetic disks or disks include Compact Discs (CDs), laser disks, optical disks, Digital Versatile Discs (DVDs), floppy disks, and Blu-ray disks, wherein magnetic disks usually copy data magnetically, and disks copy data optically via laser. Combinations of the above are also included in the scope of computer-readable media.

In one or a plurality of embodiments, the use of the words “able”, “can”, “operable as” or “configured as” refers to some devices, logics, hardware and/or components designed to be used in a specified manner. The subject matter of the present disclosure is provided as an example of the apparatus, system, method, and program for performing the features described in the present disclosure. However, in addition to the aforementioned features, other features or modifications can be expected. It can be expected that any emerging technology that may replace any of the aforementioned realized technologies may be used to complete the realization of the components and functions of the present disclosure.

In addition, the above description provides examples without limiting the scope, applicability, or configuration set forth in the claims. Without departing from the spirit and scope of the present disclosure, changes may be made to the functions and layouts of the discussed components. Various embodiments may omit, substitute, or add various processes or components as appropriate. For example, features described with respect to some embodiments may be combined in other embodiments.

Similarly, although operations are depicted in a specific order in the attached drawings, this should not be understood as a requirement that such operations should be executed in the specific order shown or in the sequential order, or that all illustrated operations be executed to achieve the desired result. In some cases, multi-tasking and parallel processing can be advantageous.

1. An electronic device, comprising:
a memory having instructions stored thereon; and
a processor, configured to execute the instructions stored in the memory to cause the electronic device to execute the following operations:
playing a first program of a first channel, wherein the first program is a live program;
receiving user input when playing the first program; and
in response to receiving the user input, switching from the first channel to a second channel and playing a second program of the second channel, wherein the second program is an OTT program.

2. The electronic device according to claim 1, wherein the processor is further configured to execute the instructions stored in the memory to cause the electronic device to execute the following operations:
receiving another user input when playing the second program;
in response to receiving the other user input, switching from the second channel to a third channel and playing a third program of the third channel, wherein the third program is a live program.

3. The electronic device according to claim 1, wherein each of the user input and the other user input includes:
inputting a channel number by a user, or
pressing a previous channel button or a next channel button by the user.

4. The electronic device according to claim 1, wherein the second channel is associated with a plurality of OTT programs from an OTT content provider.

5. The electronic device according to claim 4, wherein the plurality of OTT programs are associated with one of the following:
a specific channel of the OTT content provider,
a specific host of the OTT content provider,
a specific topic of the OTT content provider,
a subscription of the user at the OTT content provider, and
a recommendation of the OTT content provider.

6. The electronic device according to claim 4, wherein in response to switching from the first channel to the second channel, the plurality of OTT programs will be played sequentially, and wherein in an electronic program guide of the electronic device, previews of the plurality of OTT programs are sequentially displayed corresponding to the second channel.

7. The electronic device according to claim 4, wherein the first program is played by a main application for playing live programs, and the second program is played by an OTT application for playing OTT programs from the OTT content provider.

8. The electronic device according to claim 7, wherein when the OTT application plays the second program, the main application remains active in background and monitors user input.

9. The electronic device according to claim 4, wherein the association of the second channel with the plurality of OTT programs is set by a user.

10. An execution method of the electronic device, comprising:
playing a first program of a first channel, wherein the first program is a live program;
receiving user input when playing the first program; and
in response to receiving the user input, switching from the first channel to a second channel and playing a second program of the second channel, wherein the second program is an OTT program.

11. The method according to claim 10, which further includes:
receiving another user input when playing the second program;
in response to receiving the other user input, switching from the second channel to a third channel and playing a third program of the third channel, wherein the third program is a live program.

12. The method according to claim 10 or 11, wherein each of the user input and the other user input includes:
inputting a channel number by a user, or
pressing a previous channel button or a next channel button by the user.

13. The method according to claim 10, wherein the second channel is associated with a plurality of OTT programs from an OTT content provider.

14. The method according to claim 13, wherein the plurality of OTT programs are associated with one of the following:
a specific channel of the OTT content provider,
a specific host of the OTT content provider,
a specific topic of the OTT content provider,
a subscription of the user at the OTT content provider, and
a recommendation of the OTT content provider.

15. The method according to claim 13, wherein in response to switching from the first channel to the second channel, the plurality of OTT programs will be played sequentially, and wherein in an electronic program guide of the electronic device, previews of the plurality of OTT programs are sequentially displayed corresponding to the second channel.

16. The method according to claim 13, wherein the first program is played by a main application for playing live programs, and the second program is played by an OTT application for playing OTT programs from the OTT content provider.

17. The method according to claim 16, wherein when the OTT application plays the second program, the main application remains active in background and monitors user input.

18. The method according to claim 13, wherein the association of the second channel with the plurality of OTT programs is set by a user.

19. A non-transitory computer-readable medium, wherein the non-transitory computer-readable medium has instructions stored thereon, and when executed by a processor of an electronic device, the instructions cause the electronic device to execute the method according to claim 10.

20. An apparatus, including a component for executing steps of the method according to claim 10.
